(19) United States
(12) Patent Application Publication
(10) Pub. No.: US 2025/0002285 A1
(43) Pub. Date: Jan. 2, 2025

(54) Electrode Fabric Transfer Device, and Electrode Notching Device Comprising the Same

(71) Applicant: LG Energy Solution, Ltd., Seoul (KR)

(72) Inventors: Hyung Mook Jung, Daejeon (KR); Byung Uk You, Daejeon (KR); Jung Han Rhee, Daejeon (KR); Hee Seung Wang, Daejeon (KR)

(73) Assignee: LG Energy Solution, Ltd., Seoul (KR)

(21) Appl. No.: 18/700,387

(22) PCT Filed: Apr. 28, 2023
(86) PCT No.: PCT/KR2023/005837

§ 371 Date: Apr. 11, 2024

(30) Foreign Application Priority Data
May 2, 2022 (KR) 10-2022-0053983

(51) Int. Cl. B65H 20/02; H01M 4/04

(52) U.S. Cl. CPC B65H 20/02; H01M 4/04; B65H 2301/443246; B65H 2301/51536

(57) ABSTRACT

An electrode fabric transfer device comprises a plurality of running rollers and an adjusting roller. The plurality of running rollers transfer an electrode fabric along a transfer path, and the adjusting roller includes a rotation shaft having a first end with a position fixed and a second end positioned in a direction opposite to the first end and capable of position movement. The adjusting roller is disposed between two adjacent running rollers. An electrode notching device comprising the same is also provided.

### CROSS-REFERENCE TO RELATED APPLICATIONS

The present application is a national phase entry under 35 U.S.C. § 371 of International Application No. PCT/KR2023/005837, filed on Apr. 28, 2023, which claims priority from Korean Patent Application No. 10-2022-0053983, filed on May 2, 2022, all of which are incorporated herein by reference.

### TECHNICAL FIELD

The present disclosure relates to an electrode fabric transfer device, and an electrode notching device comprising the same.

### BACKGROUND ART

A secondary battery is a rechargeable battery manufactured using a material in which a number of redox processes between the current and the material can be repeated.

In the conventional art, an electrode assembly, a lithium secondary battery using the same, and a manufacturing method of the lithium secondary battery are disclosed.

In order to manufacture an electrode of a conventional secondary battery, an active material is coated on an electrode fabric (or also referred to as an electrode sheet), and then the active material coated portion is rolled.

However, there is a problem that due to a difference in stretchability between the coated portion coated with the active material and the uncoated portion uncoated with the active material during rolling of the electrode sheet, tension imbalances after rolling occurs, and phenomena such as swells occur in the electrode base material.

In addition, there is a problem that wrinkles (or called swells) or folding phenomena occur due to a difference in tension between the coated portion and the uncoated portion during transportation of the electrode sheet for coating and rolling.

Due to the above-described phenomena, there is a problem of causing notching defects or electrode breakages during a notching process or a press process of the electrode.

### DISCLOSURE

### Technical Problem

It is a problem to be solved by an aspect of the present invention to provide an electrode fabric transfer device capable of preventing occurrence of electrode swells in the electrode fabric under transportation.

### Technical Solution

In order to solve the above problem, according to one aspect of the present invention, an electrode fabric transfer device is provided, which comprises a plurality of running rollers transfer an electrode fabric along a transfer path, and an adjusting roller including a rotation shaft having a first end with a position fixed and a second end positioned in a direction opposite to the first end and capable of position movement, and disposed between the two adjacent running rollers.

Also, the electrode fabric transfer device may comprise a support frame supporting the first end of the rotation shaft, and a hinge member hinge-connecting the first end of the rotation shaft and the support frame.

In addition, the electrode fabric transfer device may comprise a control lever, which is connected to the second end of the rotation shaft, for manually adjusting the position movement of the second end of the rotation shaft, and a seating frame located between the second end of the rotation shaft and the control lever and seated by the second end of the rotation shaft.

Furthermore, in the electrode fabric transfer device, the area of the adjusting roller contacting the electrode fabric may be adjusted based on the position of the second end of the rotation shaft.

Also, the electrode fabric transfer device may comprise a movement distance measuring part measuring a movement distance of the second end of the rotation shaft.

In addition, the electrode fabric transfer device may comprise a position fixing part for fixing the position of the second end of the rotation shaft.

Furthermore, the electrode fabric transfer device may be provided so that the position of the second end of the rotation shaft is moved based on the tensile force applied to the uncoated portion region of the electrode fabric.

Also, the electrode fabric transfer device may be provided so that when the tensile force applied to the uncoated portion of the electrode fabric increases, the second end of the rotation shaft is moved upward.

In addition, the transfer path may comprise at least one curved region, and the adjusting roller may be located in the curved region.

Furthermore, according to another aspect of the present invention, an electrode notching device is provided, which comprises the electrode fabric transfer device, and a cutting part cutting the electrode fabric transferred from the electrode fabric transfer device along a set reference line using a laser.

### Advantageous Effects

As described above, according to the electrode fabric transfer device related to at least one example of the present invention, the tension of the coated portion and the uncoated portion of the electrode fabric being transported can be maintained uniformly by moving the position of the adjusting roller, and accordingly, it is possible to prevent electrode swells due to the tension imbalance.

### DESCRIPTION OF DRAWINGS

FIGS. 1 and 2 are conceptual diagrams showing an electrode transfer device according to an embodiment of the present invention.

FIG. 3 is a diagram for explaining a wrinkle occurrence position of an electrode fabric.

FIGS. 4 to 6 are conceptual diagrams for explaining the operating principle of the adjusting roller of the electrode transfer device according to an embodiment of the present invention.

FIG. 7 is a configuration diagram of an electrode fabric transfer device according to an embodiment of the present invention.

### DETAILED DESCRIPTION

Hereinafter, an electrode fabric transfer device according to one example of the present invention will be described in detail with reference to the accompanying drawings.

In addition, regardless of the reference numerals, the same or corresponding components are given by the same or similar reference numerals, duplicate descriptions thereof will be omitted, and for convenience of explanation, the size and shape of each component member as shown can be exaggerated or reduced.

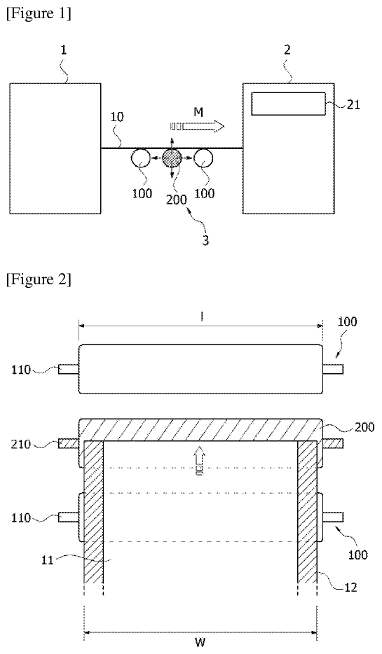

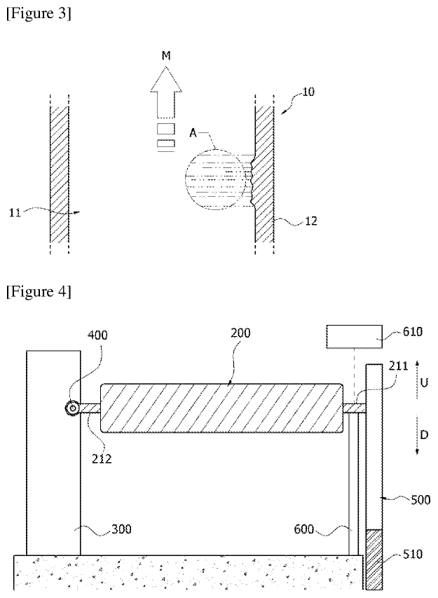

FIGS. 1 and 2 are conceptual diagrams showing an electrode transfer device (3) according to an embodiment of the present invention, and FIG. 3 is a diagram for explaining a wrinkle occurrence position of an electrode fabric.

An embodiment of the present invention relates to an electrode fabric transfer device (3). The electrode fabric transfer device (3) may be a device transfer an electrode fabric (10) from a press device (1) for rolling an electrode to an electrode notching device (2).

The electrode fabric (10) comprises, for example, a coated portion (11) coated with an active material and an uncoated portion (12) not coated with an active material. In general, the coated portion (11) may be formed in the central portion of the electrode fabric (10), and the uncoated portion (12) may be formed at the edges along the width direction (w) of the electrode fabric (10).

The electrode fabric transfer device (3) comprises a plurality of running rollers (100) transfer an electrode fabric (10) along a transfer path (M), and an adjusting roller (200) including a rotation shaft (210) having a first end with a position fixed and a second end positioned in a direction opposite to the first end and capable of position movement, and disposed between the two adjacent running rollers (100).

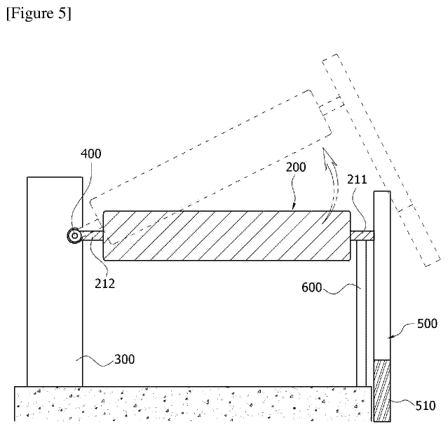

FIGS. 4 to 6 are conceptual diagrams for explaining the operating principle of the adjusting roller of the electrode transfer device according to an embodiment of the present invention. Specifically, FIG. 5 is a side view showing a vertical movement state of the adjustment roller, and FIG. 6 is a plan view showing a horizontal movement state of the adjustment roller.

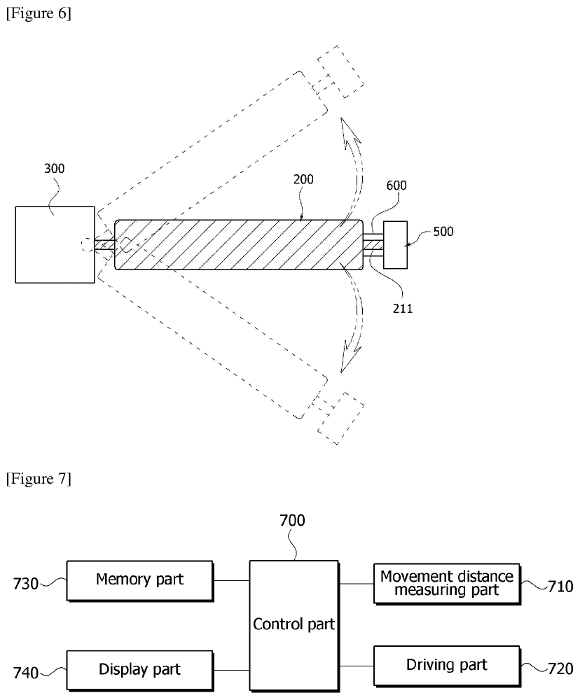

In addition, FIG. 7 is a configuration diagram of an electrode fabric transfer device according to an embodiment of the present invention.

In the electrode fabric (10) during transfer, wrinkles (A) may occur due to a difference in tension (or called tensile force) between the coated portion (11) and the uncoated portion (12), and these wrinkles (A, or referred to as swells) may cause notching failure or electrode breakage problems.

The electrode fabric transfer device (3) according to an embodiment of the present invention is intended to remove the swells (A) generated by the tension imbalance, where the above object can be achieved by providing the adjusting roller (200) capable of left, right, up and down movement.

Specifically, the electrode fabric transfer device (3) comprises a plurality of running rollers (100) and an adjusting roller (200).

The plurality of running rollers (100) transfers the electrode fabric (10) along the transfer path (M). Each running roller (100) has a rotation shaft (110) passing through the central shaft along the longitudinal direction (1).

In addition, the running roller (100) comprises a driving part rotating the rotation shaft (110) so that the electrode fabric (10) travels along the transfer direction (M). The driving part may be a motor.

For example, the transfer path (M) may be a path connecting the press device (1) and the electrode notching device (2).

In addition, the electrode fabric (10) may have an uncoated portion (12) formed at an edge along the width direction (w). The uncoated portion (12) may be formed at one end or both ends along the width direction (w) according to the model of the electrode fabric.

The adjusting roller (200) is disposed between the two adjacent running rollers (100). In addition, the adjusting roller (200) comprises a rotation shaft (210) having a first end (212) with a position fixed and a second end (211) positioned in a direction opposite to the first end (212) and capable of position movement.

The rotation shaft (210) of the adjusting roller (200) is formed by passing through the central shaft of the adjusting roller (200) along the longitudinal direction (1) so that the adjusting roller (200) idle-rotates. The rotation shaft (210) is provided to idle-rotate in a process that the electrode fabric (10) passes along the adjusting roller (200), where a separate driving part may not be connected to the rotation shaft (210).

The second end (211) of the rotation shaft (210) may be capable of position movement to the left, right, up, and down. Specifically, FIG. 5 shows that the rotation shaft (210) of the adjusting roller (200) moves in the up and down directions, and FIG. 6 shows that the rotation shaft of the adjusting roller (200) moves in the left and right directions. In this way, the adjusting roller (200) may move in association with the movement of the rotation shaft (210).

Specifically, the electrode fabric transfer device (3) may comprise a support frame (300) supporting the first end (212) of the rotation shaft (210), and a hinge member (400) hinge-connecting the first end (212) of the rotation shaft (210) and the support frame (300).

The hinge member (400) connects the first end (212) and the support frame (300) so that the rotation shaft (210) can be tilted at a predetermined angle. The first end (212) of the rotation shaft (210) may rotate at a fixed position on the support frame (300). The first end (212) of the rotation shaft (210) may be fixed by hinge coupling with the support frame (300).

In one example, the electrode fabric transfer device (3) may comprise a control lever (500), which is connected to the second end (211) of the rotation shaft (210), for manually adjusting the position movement of the second end (211) of the rotation shaft (210), and a seating frame (600) located between the second end (211) of the rotation shaft (210) and the control lever (500) and seated by the second end (211) of the rotation shaft (210).

The control lever (500) serves as a kind of control handle, where a gripping part (510) for a user to grip may be provided at one end of the control lever (500). The user may move the position of the second end (211) of the rotation shaft (210) by applying force in a desired direction left, right, up, or down in a state of holding the control lever (500). The second end (211) may be separated from the seating frame (600) upon position movement.

Meanwhile, the electrode fabric transfer device (3) may be provided to enable automatic adjustment instead of manual adjustment. At this time, various driving parts, such as a cylinder and a motor, for automatically adjusting the position of the second end (211) of the rotation shaft (210) may be applied instead of the control lever (500). In addition, when automatically adjusting, it may be designed to be remotely adjustable.

As one example, the electrode fabric transfer device (3) may also further comprise a driving part (720) for moving the second end (211) of the rotation shaft (210). The driving part (720) may comprise a motor or a cylinder (pneumatic, hydraulic, etc.). In addition, the electrode fabric transfer device (3) may comprise a control part (700) for controlling the driving part (720).

In addition, the electrode fabric transfer device (3) may be provided so that the area of the adjusting roller (200) in contact with the electrode fabric (10) is adjusted according to the position of the second end (211) of the rotation shaft (210). As one example, the area of the adjusting roller (200) in contact with the electrode fabric (10) may be adjusted, based on at least one of the rotation angle of the first end (212) of the rotation shaft (210) and the position of the second end (211) of the rotation shaft (210).

The electrode fabric transfer device (3) related to one example of the present invention can solve the tension imbalance between the coated portion (11) and the uncoated portion (12) by adjusting the area of the adjusting roller (200) in contact with the electrode fabric (10).

In another example, the electrode fabric transfer device (3) may comprise a movement distance measuring part (710) measuring a movement distance of the second end (211) of the rotation shaft (210). The movement distance measuring part (710) may be provided to measure a horizontally moved movement distance (left or right direction) or a vertically moved movement distance (up or down direction) based on the state where the second end (211) of the rotation shaft (210) is seated on the seating frame (600). Through the movement distance measuring part (710), an optimal movement distance maintaining a tension balance between the coated portion (11) and the uncoated portion (12) of the electrode fabric (10) can be confirmed.

Also, the control part (700) may be electrically connected to the movement distance measuring part (710). The movement distance measured by the movement distance measuring part (710) may be transmitted to the control part (700).

At this instance, when the state in which the second end (211) of the rotation shaft (210) is seated on the seating frame (600) is set to an initial position, and the second end (211) is moved by a predetermined distance along the up and down directions or the left and right directions at the initial position, the movement distance measuring part (710) may be provided to measure the movement distance of the changed position compared to the initial position.

Also, the electrode fabric transfer device (3) may comprise a memory part (730) connected to the control part (700). In addition, the tensile force information applied to the uncoated portion of the electrode fabric (10) and the movement distance information measured through the movement distance measuring part (710) may be stored in the memory part (730).

The tensile force information may comprise the magnitude and direction of the tensile force, and the movement distance information may comprise the movement distance and the movement direction. Through the information thus stored in the memory part (730), the control part (700) may be provided to calculate the moving distance of the second end (211) of the rotation shaft (210) based on the tensile force applied to the region of the uncoated portion (12). In addition, the control part (700) may be provided to calculate the movement distance and direction of the second end (211) of the rotation shaft (210) based on at least one of the magnitude and direction of the tensile force applied to the region of the uncoated portion (12).

In addition, the control part (700) may display the calculated movement distance and movement direction to the outside through a display part (740). When the adjusting roller (200) is provided in a manually adjusting manner, the operator can adjust the position of the second end (211) of the adjusting roller (200) according to the movement distance and movement direction displayed on the display part (740).

Alternatively, when the adjusting roller (200) is provided in an automatic manner, the control part (700) calculates the movement distance and direction of the second end (211) of the rotation shaft (210) based on at least one of the magnitude and direction of the tensile force applied to the uncoated portion (12) region, and the control part (700) controls the driving part (720), whereby it may adjust the position of the second end (211) of the adjusting roller (200).

In addition, the electrode fabric transfer device (3) may comprise a position fixing part (610) for fixing the position of the second end (211) of the rotation shaft (210). The position fixing part (610) may allow for the position to be fixed in a state where the second end (211) of the rotation shaft (210) is seated on the seating frame (600). In addition, after unfixing the position fixing part (610), the second end (211) of the rotation shaft (210) may be subjected to position movement.

Referring to FIGS. 4 to 6, based on the tensile force (or referred to as tension) applied to the region of the uncoated portion (12) of the electrode fabric (10), the position of the second end (211) of the rotation shaft (210) may be moved. When the tensile force applied to the region of the uncoated portion (12) increases, the second end (211) of the rotation shaft (210) may be moved upward (U). Through the upward movement of the rotation shaft (210), the adjusting roller (200) pressurizes the lower portion of the electrode fabric (10), so that the tensile force applied to the uncoated portion (12) region may be relieved. The tensile force applied to the uncoated portion (12) region and the upward movement distance of the rotation shaft (210) for tensile force relief tend to be proportional, and as the tensile force applied to the uncoated portion (12) region increases, the upward movement distance of the rotation shaft (210) for tensile force relief may increase. Therefore, when the tensile force applied to the uncoated portion (12) is reduced during the transfer, it is possible to precisely adjust the force in which the adjusting roller (200) pressurizes the lower portion of the electrode fabric (10) through the downward (D) movement of the rotation shaft (210).

As described above, the electrode fabric transfer device (3) may also further comprise a driving part (720) for moving the second end (211) of the rotation shaft (210). Also, the control part (700) may be provided to calculate the movement distance and direction of the second end (211) of the rotation shaft based on one or more of the magnitude and direction of the tensile force applied to the region of the uncoated portion (12), and the control part (700) may control the driving part (720) so that the second end (211) of the rotation shaft is moved according to the calculated movement distance. In addition, the control part (700) may be provided to check whether the second end (211) of the rotation shaft has moved by the calculated distance through the movement distance measuring part (710).

As one example, when it is determined that the tensile force applied to the uncoated portion (12) increases, the control part (700) may increase the upward movement distance of the second end (211) of the rotation shaft (210). In addition, when it is determined that the tensile force applied to the uncoated portion (12) decreases, the control part (700) may reduce the upward movement distance of the second end (211) of the rotation shaft (210).

In another example, the transfer path (M) may comprise at least one curved region, and the adjusting roller (200) may be located in the curved region. Since a lot of tension imbalances occur between the coated portion (11) and the uncoated portion (12) of the electrode fabric (10) in the curved region, it may be effective to relieve the tension imbalances by disposing the adjusting roller (200) on the curved region.

Another example of the present invention relates to an uncoated portion press device. The uncoated portion press device may be a press device for electrode notching. The uncoated portion press device comprises the above-described electrode fabric transfer device (3) and a pressurizing part pressurizing the uncoated portion region of the electrode fabric transferred from the transfer device to form a pattern. The electrode fabric transfer device is installed at the front end of the pressurizing part to transfer the electrode fabric, in which the tension balance between the coated portion and the uncoated portion is maintained, to the pressurizing part.

The uncoated portion press device has an advantage that the electrode breakage problem due to the tension imbalance between the coated portion and the uncoated portion during the pressurizing process is improved by using the electrode fabric, in which the tension balance between the coated portion and the uncoated portion is maintained, from the above-described electrode fabric transfer device. To the uncoated portion press device, other equipment except for the electrode fabric transfer device may be applied without limitation.

In addition, an embodiment of the present invention relates to an electrode notching device (2) comprising the electrode fabric transfer device (3). The notching device (2) may comprise the above-described electrode fabric transfer device and a cutting part (21) cutting the electrode fabric from the transfer device along a set reference line using a laser. The electrode fabric transfer device (3) is installed at the front end of the cutting part (21).

As the electrode fabric (10), in which the tension balance between the coated portion and the uncoated portion is maintained, is supplied from the electrode fabric transfer device (3), the notching device (2) has an advantage that notching defects due to tension imbalances between the coated portion and the uncoated portion during the cutting process are improved. In addition, the notching device (2) may be implemented in various notching methods.

The preferred examples of the present invention as described above have been disclosed for illustrative purposes, and those skilled in the art having ordinary knowledge of the present invention will be able to make various modifications, changes, and additions within the spirit and scope of the present invention, and such modifications, changes, and additions should be regarded as falling within the scope of the following claims.

### INDUSTRIAL APPLICABILITY

According to the electrode fabric transfer device related to at least one example of the present invention, the tension between the coated part and the uncoated part of the electrode fabric under transfer can be maintained uniformly by moving the position of the adjusting roller, and accordingly, the electrode swells caused by the tension imbalances can be prevented.

1. An electrode fabric transfer device comprising:
a plurality of running rollers configured to transfer an electrode fabric along a transfer path; and
an adjusting roller disposed between the plurality of running rollers, wherein the adjusting roller includes a rotation shaft having a first end disposed in a fixed position and a second end positioned opposite to the first end, and
wherein a position of the second end is moveable.

2. The electrode fabric transfer device according to claim 1, comprising:
a support frame supporting the first end of the rotation shaft; and
a hinge member hinge-connecting the first end of the rotation shaft and the support frame.

3. The electrode fabric transfer device according to claim 1, comprising:
a control lever connected to the second end of the rotation shaft and configured to manually adjust the position of the second end of the rotation shaft; and
a seating frame located between the second end of the rotation shaft and the control lever.

4. The electrode fabric transfer device according to claim 2, wherein
an area of the adjusting roller configured to contact the electrode fabric is adjusted based on the position of the second end of the rotation shaft.

5. The electrode fabric transfer device according to claim 1, comprising:
a movement distance measuring part configured to measure a movement distance of the second end of the rotation shaft.

6. The electrode fabric transfer device according to claim 1, comprising
a position fixing part configured to fix the position of the second end of the rotation shaft.

7. The electrode fabric transfer device according to claim 1, wherein
the position of the second end of the rotation shaft is configured to moved based on a tensile force applied to a region of an uncoated portion of the electrode fabric.

8. The electrode fabric transfer device according to claim 7, wherein
the second end of the rotation shaft is configured to move upward when the tensile force applied to the region of the uncoated portion of the electrode fabric increases.

9. The electrode fabric transfer device according to claim 1, wherein
the transfer path comprises at least one curved region, and
the adjusting roller is located in the at least one curved region.

10. An electrode notching device comprising:
the electrode fabric transfer device according to claim 1; and
a cutting part configured to cut the electrode fabric along a set reference line using a laser.
